(19) United States
(12) Patent Application Publication
(10) Pub. No.: US 2002/0149731 A1
(43) Pub. Date: Oct. 17, 2002

(54) Display device and method of manufacturing such a display device

(76) Inventors: Peter Jan Slikkerveer, Eindhoven (NL); Alexander Victor Henzen, Heerlen (NL); Petrus Cornelis Paulus Bouten, Eindhoven (NL)

Correspondence Address: U.S. Philips Corporation, 580 White Plains Road, Tarrytown, NY, 10591, US

(21) Appl. No.: 10/109,747

(22) Filed: Mar. 29, 2002

(30) Foreign Application Priority Data
Mar. 29, 2001 (EP) 01201182.1

(51) Int. Cl. G02F 1/1339

(52) U.S. Cl. 349/153

(57) ABSTRACT

The row and column conductors (5,6) of a (passive LCD) display are realized by way of vias (8) through the backpanel and establish electric connections on the rear side of the display. A further wiring pattern (9) may be provided on the rear side so as to realize further interconnections.

The invention relates to a display device comprising a first substrate provided with a first conductor pattern on a first side, said display device having a layer of electro-optical material and being provided with a second conductor pattern on a second side of the first substrate.

Examples of such display devices are LCDs which are used in laptop computers and in organizers, but they also find an increasingly wider application in GSM telephones.

The use of such display devices in “white paper” applications is also increasingly considered. The display device then has the appearance of a newspaper. Since the substrate is flexible when using plastic displays, it may be rolled up partly or not partly (or sometimes folded). This flexibility also provides the possibility of using these devices in “wearable” displays. Instead of LCDs, for example, (organic) LED devices may also be used.

U.S. Pat. No. 5,436,744 describes a liquid crystal display device in which a first flexible substrate is provided with a first conductor pattern on a first side, in which pattern picture electrodes are incorporated, and in which a second side of the first substrate is provided with a second conductor pattern. A considerable portion of the first conductor pattern, such as the wiring for connections with a drive IC, which, during a first step of manufacturing this display device, is situated outside the actual area which (at a later stage) is visible to the viewer. This particularly applies to electrically conducting connections between the second conductor pattern and the first conductor pattern (referred to as vias).

In a later step, said portion is folded together with the further connections and the drive IC completely or not completely behind the actual area which is visible to the viewer. This takes up the necessary space because (a part of the fold) projects from this area so that the ultimate display device covers a larger surface area. In the ultimate display device, there will be room needed outside the actual area which is visible to the viewer. To prevent breakage of the conductors, the radius of curvature of the fold should not be too small.

In another example, in which said portion is only half folded (an angle of 90°), this requires extra depth of the housing, which is not acceptable, particularly in portable applications such as GSM telephones. Here again, the radius of curvature of the fold should not be too small.

Moreover, said patent describes a glass substrate used as the second substrate. Apart from the fact that glass is not flexible, the combination of a glass substrate and a flexible substrate of, for example, a synthetic material involves various problems due to the difference between thermal and mechanical properties.

However, a very great drawback is that during the manufacture of the display device room must be reserved on the first substrate for a portion of the first conductor pattern such as the wiring for the connections with a drive IC. This requires a considerable quantity of extra substrate surface, not only of the first substrate, but also of a possible second substrate, in which the portion of the second substrate facing this extra substrate surface must be removed again at a later stage. The quantity of glass surface for each display device (also referred to as “footprint”) thus occupies a much larger surface area than the actual display area.

It is an object of the invention to at least partly solve or alleviate one or more of the above-mentioned problems. In a display device according to the invention, electrically conducting connections between the second conductor pattern and the first conductor pattern are situated transverse to the surface of the first substrate, viewed mainly within the surface of the layer of electro-optical material or within the surface which is substantially defined by the layer of electro-optical material and a sealing rim surrounding the layer of electro-optical material. In this application, the phrase “substantially defined by the layer of electro-optical material and a sealing rim surrounding the layer of electro-optical material” is not only understood to mean exclusively the surface defined by the layer of electro-optical material and a sealing rim surrounding the layer of electro-optical material. In practice, this surface may extend as far as a small edge (up to 2 mm) around said sealing rim, which is due to manufacturing tolerances of said sealing rim and tolerances in the provision of the electrically conducting connections between the second conductor pattern and the first conductor pattern.

The invention is based on the recognition that it is possible to reduce the quantity of substrate surface for one display device, or per semi-product (“footprint”) considerably by means of electrically conducting connections between the second conductor pattern and the first conductor pattern which are situated substantially entirely within the actual display area (or within the surface substantially defined by the layer of electro-optical material and a sealing rim surrounding the layer of electro-optical material). Moreover, it is no longer necessary to reserve space on the first substrate for connections with a drive IC. In certain applications, the conductor pattern may therefore be (partly) limited to bond pads or bumps for contacting, for example, ICs or connectors. This leads to an efficient use of the substrate material.

The layer of electro-optical material may be situated between the first substrate and at least a further electrode pattern, in which electrically conducting connections between the second conductor pattern and the further electrode pattern are also situated within the surface of the layer of electro-optical material or within the surface defined by the layer of electro-optical material and a sealing rim surrounding the layer of electro-optical material.

The electrically conducting connections between the second conductor pattern and the first conductor pattern or electrically conducting connections between the second conductor pattern and the further electrode pattern are preferably situated exclusively at the area of, or proximate to, the sealing rim (or a part thereof) of the layer of electro-optical material. The expression “proximate to the sealing rim” is again understood to mean that, due to the above-mentioned manufacturing tolerances, the electrically conducting connections between the second conductor pattern and the first conductor pattern may be situated in an area (up to 2 mm) around said sealing rim. By realizing the electrically conducting connections only at the area of the sealing rim, the first substrate can be transparent within the display area. This may be notably advantageous in transmissive display devices which are provided with a further substrate or a foil with a wiring pattern, in which the second conductor pattern is connected in an electrically conducting manner to the wiring pattern, and the further substrate or foil has an aperture at the area of the surface of the layer of electro-optical material.

A method according to the invention comprises the steps of

a) providing, on a first substrate, at least a first conductor pattern on a first side of the first substrate and a second conductor pattern on a second side of the first substrate

b) providing, if necessary, at least a further conductor pattern on a second substrate

c) providing electrically conducting connections between the second conductor pattern and the first conductor pattern and, if necessary, providing electrically conducting connections between the further conductor pattern or between the second conductor pattern and the further conductor pattern

d) providing sealing rims, and

e) mutually separating parts of the first substrate.

A further method, particularly suitable for liquid crystal display devices, comprises the further steps of

f) providing at least a further conductor pattern on a second substrate

g) viewed transversely to the surfaces of the substrates, mutually separating the first and the second substrate along substantially identical lines.

Since the quantity of substrate surface per display device (also referred to as “footprint”) is substantially identical for both substrates, parts of the first and the second substrate can now be broken simultaneously. This usually results in a semi-product. For the actual display device (notably liquid crystal display devices), this should be provided with further elements such as, for example, polarizers.

It should be noted that the second substrate does not always need to be provided with a further conductor pattern, for example, in display devices based on “in-plane switching”. In (organic) LED display devices, a (metal) protective layer may be provided instead of a second substrate.

These and other aspects of the invention are apparent from and will be elucidated with reference to the embodiments described hereinafter.

In the drawings:

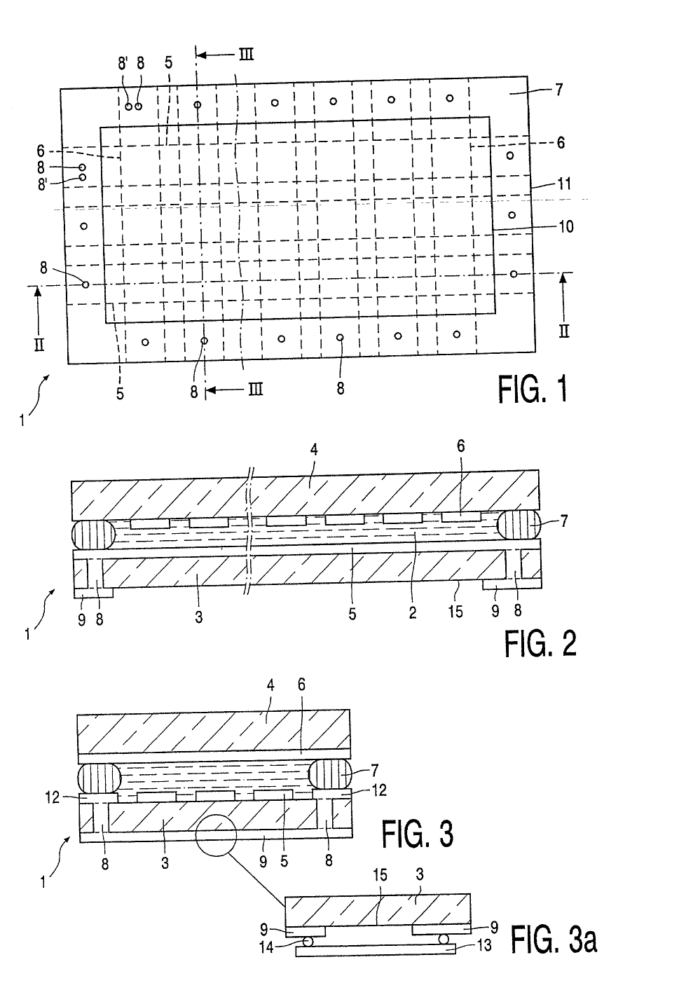

FIG. 1 is a diagrammatic plan view of a display device according to the invention,

FIG. 2 is a cross-section taken on the line II-II in FIG. 1,

FIG. 3 is a cross-section taken on the line III-III in FIG. 1,

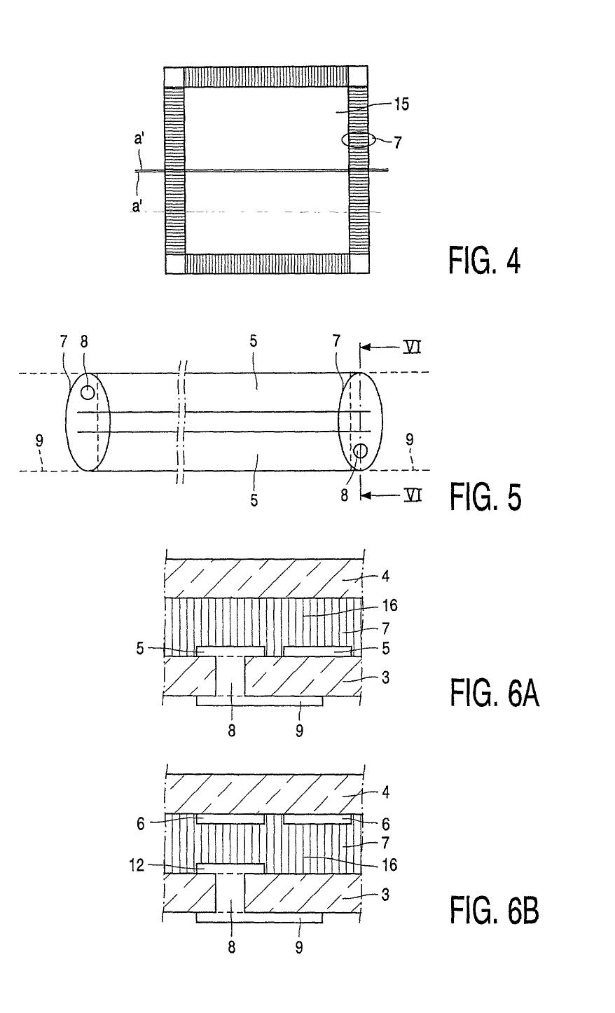

FIG. 4 is a possible elevational view of a surface of the display device of FIG. 1,

FIG. 5 shows a part of FIG. 4 in an enlarged form,

FIG. 6 is a cross-section taken on the line VI-VI in FIG. 5,

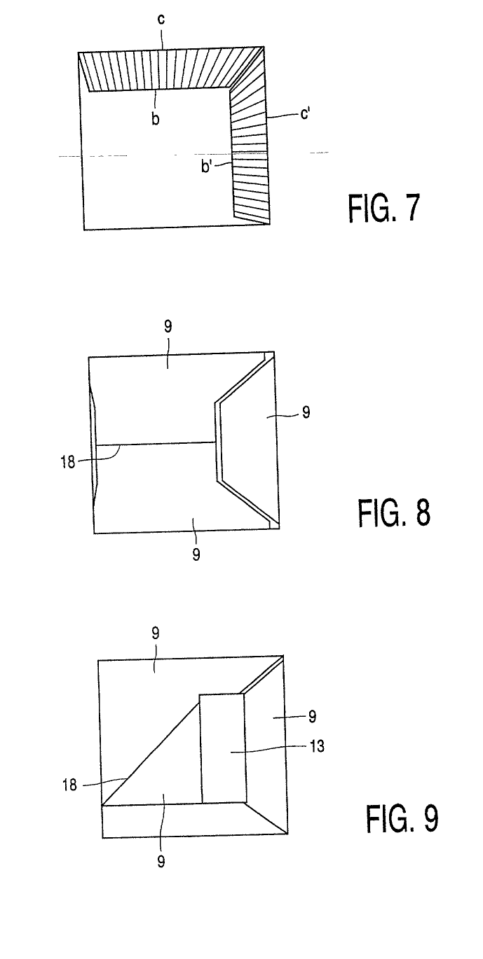

FIGS. 7 to 9 show variants of FIG. 5,

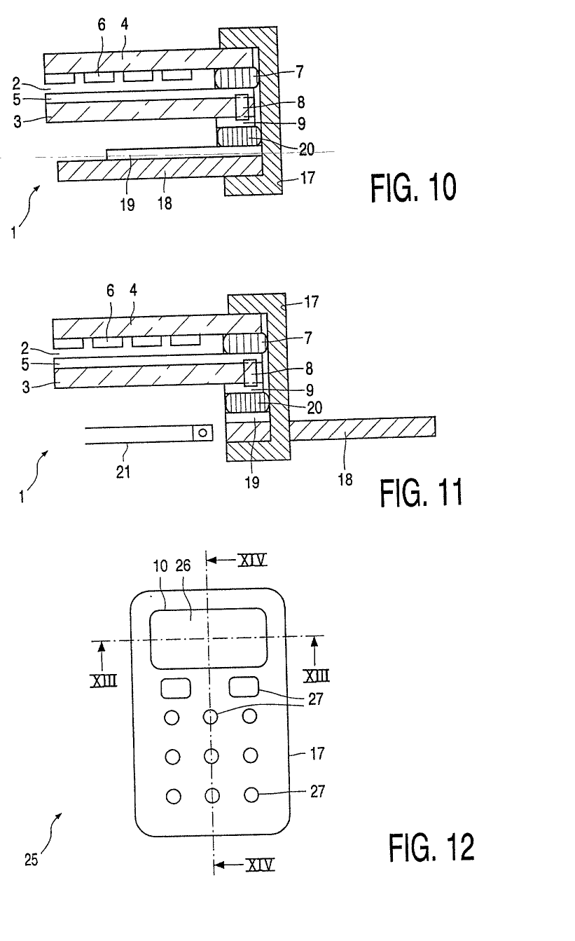

FIGS. 10 and 11 are cross-sections of other possible display devices according to the invention,

FIG. 12 shows an application of a display device according to the invention,

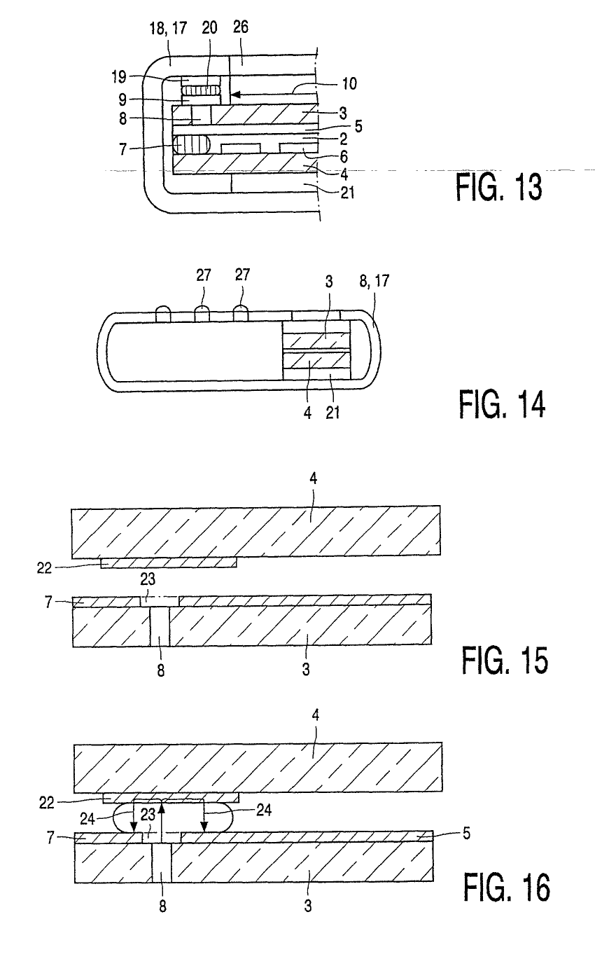

FIG. 13 is a cross-section taken on the line XIII-XIII in FIG. 12, while

FIG. 14 is a cross-section taken on the line XIV-XIV in FIG. 12, and

FIGS. 15 and 16 illustrate another display device according to the invention.

The Figures are diagrammatic and not drawn to scale; corresponding parts are generally denoted by the same reference numerals.

FIG. 1 is a diagrammatic plan view and FIG. 2 is a cross-section of a part of a display device 1 with a nematic liquid crystal material 2 which is situated between two substrates 3, 4 of a synthetic material (for example, polycarbonate or polyethersulphon) provided with electrodes 5, 6. Together with the intermediate liquid crystal material 2, crossings of the electrodes define pixels. If necessary, the display device comprises orientation layers which orient the liquid crystal material on the inner walls of the substrates. The liquid crystal material is enclosed by a sealing rim 7 which consists of anisotropic conducting material.

Electrically conducting connections (vias) 8 connect the first conductor pattern (the electrodes 5) to a conductor pattern 9. In certain applications, the conductor pattern may be (partly) limited to bond pads or bumps for contacting, for example, ICs or connectors. According to the invention, the vias 8 are situated transversely to the surface of the first substrate, viewed within the surface 10 (indicated by means of a rectangle in FIG. 1) of the layer of electro-optical material, or within the surface 11 (also indicated by means of a rectangle in FIG. 1) defined by the layer of electro-optical material and a sealing rim surrounding the layer of electro-optical material. The surface 10 defines the actual display surface. In the relevant example, the electrodes 6 are arranged via the sealing rim 7, parts 12 of the electrode pattern 5 and the vias 8, parallel to substantially identically formed strip-shaped electrodes of the conductor pattern 9. In this example, the display device is of the transmissive type. The substrates 3, 4 and the electrodes 5, 6 are therefore transparent, while the device is provided in generally known manner with a light source (backlight or front light) and possible other conventional elements such as polarizers etc. The device may also be formed as a reflective display device, in which, for example, the substrate 3 is opaque (and possibly also the electrodes 5, 9, 12). On the side 15 of the substrate 3 remote from the electro-optical material (liquid crystal material), a drive IC 13 can then be realized which is connected in an electrically conducting manner to the conductor pattern 9 via conducting contacts 14 (bumps). This is shown diagrammatically in FIG. 3a.

FIG. 4 shows another possible pattern of electrodes on the side 15 remote from the liquid crystal material. The conducting tracks 9 are now substantially exclusively situated in the area of the sealing rim 7. In FIG. 5, the portion between the lines a and a′ of a surface at the area of the electrodes 5 in FIG. 4 is shown in an enlarged form. Two juxtaposed electrodes 5 on the substrate 3 are each connected on only one side to electrodes of the conductor pattern 9 via an electrically conducting connection (via) 8. This is elucidated in FIG. 6A. FIG. 6B shows how two juxtaposed electrodes 6 on the substrate 4 are each similarly connected on only one side to electrodes of the conductor pattern 9 via an electrically conducting connection (via) 8. To this end, the conductor pattern on the substrate 3 comprises extra connection faces 12, while the sealing rim 7 is formed as an anisotropically conducting rim (the vertically conducting tracks are denoted by reference numeral 16). It is thereby achieved that the connections 9 may be wider (or may be provided at the same width and at the double pitch of the electrodes 5, 6 and hence of the pixels).

FIGS. 7 to 9 show other possibilities of making use of the conductor pattern 9. FIG. 7 shows diagrammatically how the pitch of the further connections 9 along the lines b, b′ may be smaller on the side 15 than that of the vias 8 (and the pitch of the row or column electrodes in the case of one-sided contacting) along the lines c, c′. However, the vias 8 (and, as in this case, also the conducting tracks 9) do not need to be situated exclusively within the area of the sealing rim 7. For example, the vias 8 may be situated along the lines b, b′, while the further connections 9 are situated at the area of lines c, c′. In that case, the external connections 9 have a larger pitch than the vias 8. This may be notably advantageous for segment displays. FIG. 8 shows diagrammatically a wiring pattern in which the further connections 9 are present halfway the display device, at the area of line 18, where one or more vias somewhere in the conductor pattern 9 connect a column electrode to a conductor from the pattern 9. FIG. 9 is an extension of FIG. 8, comparable with FIG. 3a, in which also a drive IC 13 is realized on the remote side 15 of the substrate 3.

In the embodiments of FIGS. 10 and 11, a further wiring pattern or conductor pattern 19 is not provided on the side 15 but on a further substrate (for example, a printed circuit board) 18 or a foil, in which the conductor pattern 9 and hence the electrodes 5 (and the electrodes 12 in an example which is comparable to FIGS. 3 and 6B) are connected in an electrically conducting manner to the wiring pattern 19. Mutual contacting of the conductor patterns 9, 19 takes place, for example, via an anisotropically conducting glue 20, similarly as described with reference to the sealing rim 7. If necessary, the assembly can be held together by means of a clamp 17. In the embodiment of FIG. 10, the clamp 17 forms part of, for example, the housing of the display device 1. The substrate 3 is, for example, opaque while the electrodes 5 are made of a reflecting material such as, for example, aluminum. A reflecting electro-optical effect such as the CLC effect may also be used.

In the example of FIG. 11, the further substrate 18 or foil has an aperture at the area of the surface of the layer of electro-optical material. In this case, the display device is of the transmissive type and comprises a backlight 21 (shown diagrammatically).

FIGS. 12, 13 and 14 show diagrammatically a mobile telephone 25 comprising such a transmissive display device, in which the backlight 21 is now situated behind the substrate 4. The housing 17 also functions as the further substrate 18 (see FIGS. 13, 14) and is provided with operating elements in a conventional manner. Otherwise, the reference numerals have the same significance as in the previous examples.

In the manufacture of a display device, the substrates 3, 4 are provided with conductor patterns 5, 6 in a customary manner. The definition of cells (semi-products) by providing sealing rims is effected in a similar way.

Various techniques are possible for providing the electrically conducting connections or vias 8. Powder blasting techniques can be used for a glass substrate 3. Since, as mentioned above, synthetic materials are preferably used for the substrate, other techniques which are customary for foils and printed circuit boards are applicable such as, for example, punching, drilling and laser perforation. The via is then completed by filling up the formed aperture with a conducting material. A possible complication that may occur is the fact that the electrode material may disappear locally, for example, due to local heating, as is diagrammatically shown in FIG. 15 in which the electrode 11 in the aperture 23 is locally thinner. Since the substrate 22 is provided with a conducting face 22 which contacts both electrode material of the electrode 5 and the bottom of the aperture 23 (and hence the via 8) via the anisotropically conducting sealing rim 7, a reliable contacting is obtained (denoted by arrows 24 in FIG. 16).

Since the quantity of substrate surface per display device (“footprint”) is substantially identical for both substrates, the first and the second substrate, viewed transversely to the surfaces of the substrates, can be separated along substantially identical lines. Parts of the first and the second substrate may be separated simultaneously in contrast to what is common practice in conventional techniques (scribing and breaking).

The protective scope of the invention is not limited to the embodiments described. For example, use can be made of other electro-optical effects. Notably, the layer of LC material can be replaced by a matrix of (organic) light-emitting diodes. In this case, areas of electro-optical material to be separated are covered by a protective layer of, for example, metal (or a metal cap) or a foil in which the metal or foil extends beyond the actual display areas. This layer (foil) and the substrate can be separated simultaneously again. The embodiment of FIG. 10 may also be formed as a transmissive device, when there is sufficient space between the substrates 3, 18, by placing a backlight in this space. As already mentioned hereinbefore, several variants of the method of making vias and the choice of materials for the (flexible) substrates are possible.

The invention resides in each and every novel characteristic feature and each and every combination of characteristic features. Reference numerals in the claims do not limit their protective scope. Use of the verb “comprise” and its conjugations does not exclude the presence of elements other than those stated in the claims. Use of the article “a” or “an” preceding an element does not exclude the presence of a plurality of such elements.

1. A display device comprising a first substrate provided with a first conductor pattern on a first side, said display device having a layer of electro-optical material and being provided with a second conductor pattern on a second side of the first substrate, and, viewed transversely to the surface of a first substrate, electrically conducting connections between the second conductor pattern and the first conductor pattern being situated substantially within the surface of the layer of electro-optical material or within the surface which is substantially defined by the layer of electro-optical material and a sealing rim surrounding the layer of electro-optical material.

2. A display device as claimed in claim 1, wherein the layer of electro-optical material is situated between the first substrate and at least a further electrode pattern and electrically conducting connections between the second conductor pattern and the further electrode pattern are situated within the surface of the layer of electro-optical material or within the surface defined by the layer of electro-optical material and a sealing rim surrounding the layer of electro-optical material.

3. A display device as claimed in claim 1 or 2, wherein the electrically conducting connections between the second conductor pattern and the further electrode pattern comprise electrically conducting connections between the second conductor pattern and the first conductor pattern.

4. A display device as claimed in claim 1 or 2, wherein the electrically conducting connections between the second conductor pattern and the first conductor pattern, or the electrically conducting connections between the second conductor pattern and the further electrode pattern are situated exclusively at the area of, or proximate to, the sealing rim of the layer of electro-optical material.

5. A display device as claimed in claim 1 or 2, wherein electrically conducting connections between the second conductor pattern and the first conductor pattern, or electrically conducting connections between the second conductor pattern and the further electrode pattern extend at least along a part of the edge of the layer of electro-optical material.

6. A display device as claimed in claim 1 or 2, wherein the first substrate is flexible.

7. A display device as claimed in claim 1 or 2, wherein the second side of the first substrate comprises drive electronics.

8. A display device as claimed in claim 1 or 2, comprising a further substrate or foil with a wiring pattern, wherein the second conductor pattern is connected to the wiring pattern in an electrically conducting manner.

9. A display device as claimed in claim 8 wherein the further substrate or foil has an aperture at the area of the surface of the layer of electro-optical material.

10. A method of manufacturing a display device as claimed in claim 6, the method comprising the steps of:
a) providing, on a first substrate, at least a first conductor pattern on a first side of the first substrate and a second conductor pattern on a second side of the first substrate
b) providing, if necessary, at least a further conductor pattern on a second substrate
c) providing electrically conducting connections between the second conductor pattern and the first conductor pattern and, if necessary, providing electrically conducting connections between the further conductor pattern or between the second conductor pattern and the further conductor pattern
d) providing sealing rims, and
e) mutually separating parts of the first substrate.

11. A method as claimed in claim 10, the method comprising the further steps of
f) providing at least a further conductor pattern on a second substrate
g) viewed transversely to the surfaces of the substrates, mutually separating the first and the second substrate along substantially identical lines.

12. A method as claimed in claim 11, wherein at least parts of the first and the second substrate are separated simultaneously.

13. A method as claimed in claim 10, the method comprising the further steps of
f) providing a second substrate or a protective layer
g) viewed transversely to the surfaces of the substrates, mutually separating the first and the second substrate, or the first substrate and the protective layer along substantially identical lines.

14. A method as claimed in claim 13, wherein at least parts of the first and the second substrate or of the first substrate and the protective layer are separated simultaneously.
